(19) United States
(12) Patent Application Publication
(10) Pub. No.: US 2021/0200692 A1
(43) Pub. Date: Jul. 1, 2021

(54) SIGNAL COMBINER

(71) Applicant: HEWLETT-PACKARD DEVELOPMENT COMPANY, L.P., Spring, TX (US)

(72) Inventors: Javier Enrique GUERRERO, Houston, TX (US); Adrian L. PATSCHKE, Houston, TX (US); Peter W. AUSTIN, Houston, TX (US)

(73) Assignee: HEWLETT-PACKARD DEVELOPMENT COMPANY, L.P., Houston, TX (US)

(21) Appl. No.: 16/077,910

(22) PCT Filed: Jun. 20, 2017
(86) PCT No.: PCT/US2017/038282

§ 371 Date: Aug. 14, 2018

(51) Int. Cl. G06F 13/10; G06F 3/16

(52) U.S. Cl. CPC G06F 13/102; G06F 3/162

(57) ABSTRACT

Examples relate to a signal combiner. A system may include a signal combiner to receive a first signal from a first peripheral device. The signal combiner may similarly receive a second signal from a second peripheral device. Further, the signal combiner may combine the first signal and the second signal into a combined signal. The system may also include a controller coupled to the signal combiner. The controller may receive the combined signal.

### BACKGROUND

Systems may use peripheral devices to perform additional functions for the system, Individual peripheral devices may include integrated indicators and systems to communicate to a user that the peripheral device is in use, has been successfully active, and/or has failed. Moreover, as each individual peripheral device may include an integrated indicator, different peripheral devices may employ distinct indicators, such that a user may differentiate between peripheral devices based on the indicator.

### BRIEF DESCRIPTION OF THE DRAWINGS

FIG. 1 is an example system including a signal combiner consistent with the disclosure.

FIG. 2 is an example method for signal combination consistent with the disclosure.

FIG. 3 is another example system including a signal combiner consistent with the disclosure.

### DETAILED DESCRIPTION

Peripheral devices may allow expanded capabilities and performance of functions within a computing system. As used herein, a peripheral device refers to a device able to be selectively coupled to a system to provide additional capabilities to the system. A peripheral device may be coupled to a system when a use for the peripheral device arises and may be disconnected from the system when the use for the peripheral device no longer exists. As used herein, to be coupled to a system refers to a connection between a peripheral device and the system such that the peripheral device is able to transmit and receive signals from the system. The peripheral device may be wirelessly coupled to the system or may utilize physical connectors, such as a Universal Serial Bus connector.

Some peripheral devices may use indicators, such as light, sound, or vibration, to indicate that they are connected to the system and are performing correctly. For example, a peripheral device may sound a chime when the peripheral device is in use. In some examples, the peripheral device may utilize a plurality of indicators, with each indicator corresponding to a particular function or use of the peripheral device. For example, a peripheral magnetic strip reader may utilize a first chime to indicate a successful read of a magnetic strip and a second chime to indicate an unsuccessful read of the magnetic strip.

A peripheral device that uses indicators may include hardware, such as speakers, integrated into the peripheral device. The integrated indicator may allow the peripheral device to engage the indicator independent of the system to which the peripheral device is coupled. However, integrated indicators may add bulk to the peripheral device, as space to accommodate the indicator may be added to the peripheral device.

Moreover, a peripheral device that includes an indicator may utilize a platform controller hub. As used herein, a platform controller hub refers to an electronic switch or gate to receive a signal from the peripheral device, determine whether to activate the indicator, and activate the indicator in response to a positive determination. A signal refers to a digital message containing information. The platform controller hub may be integrated with the system to which the peripheral device is coupled. In some examples, the platform controller hub may determine that the peripheral device is coupled to the system and is thus able to be used by the system. In such examples, the platform controller hub may receive a signal, such as an activation signal, from the peripheral device. The platform controller hub may then determine that the peripheral device is coupled to the system and transmit a signal to the system indicating the presence of the active peripheral device in response.

In some examples, the platform controller hub may include an OR gate. An OR gate refers to a Boolean operator that gives a value of one if an input has a value of one and gives a value of zero in all other circumstances. For example, an OR gate may give an output signal (corresponding to a value of one) in response to receipt of a particular input signal, and refrain from giving an output signal (corresponding to a value of zero) when other input signals are received. In the case of a peripheral device, the platform controller hub may transmit an output signal to activate the indicator when there has been successful activation of the peripheral device.

In systems using a plurality of peripheral devices, each peripheral device may operate independently. This may complicate the system because each peripheral device is operating according to its own parameters. Additionally, certain features of the indicator, such as sound, volume, or tone, may not be easily controlled because the peripheral device indicator may lack capabilities to change the indicator parameters. Moreover, the system to which the plurality of peripheral devices are coupled may lack the capability to allow changes to individual parameters of individual peripheral devices.

A signal combiner according to the present disclosure may allow indicators from peripheral devices to be offloaded from each individual peripheral device. This may allow peripheral devices to become smaller because indicators may not be included within the peripheral device itself. A signal combiner may receive an input from a plurality of peripheral devices. The signal combiner may combine the input signals from the plurality of peripheral devices and forward the combined signal, such that each peripheral device's particular indicator is able to be activated.

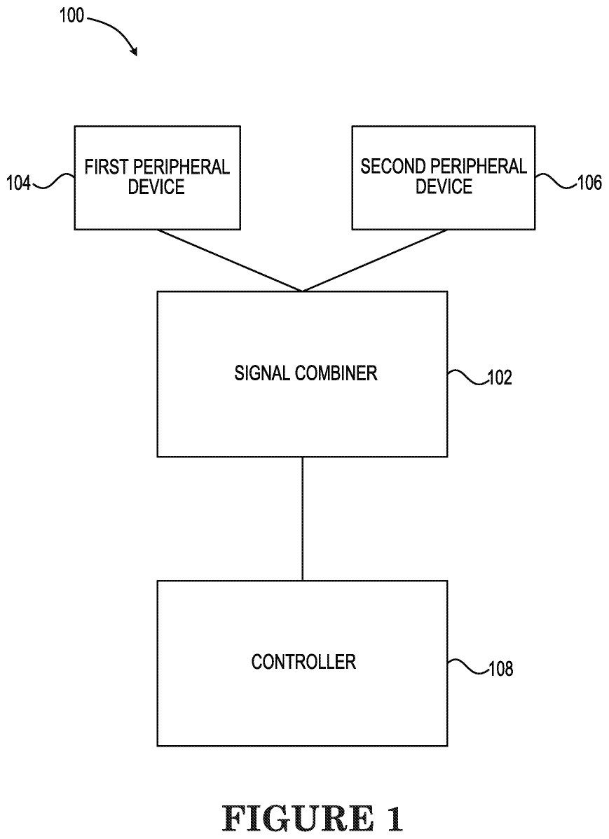

FIG. 1 is an example system 100 including a signal combiner 102 consistent with the disclosure. As used herein, a signal combiner refers to a hardware device to combine input signals received from external inputs. Signal combiner 102 may be coupled to a first peripheral device 104 and a second peripheral device 106. As described previously, a peripheral device is a device external to a system, such as system 100, that is able to be selectively coupled to the system. Examples of peripheral device 104 and/or peripheral device 106 may include a magnetic strip reader, a barcode scanner, a thermal printer, a peripheral controller hub, and a fingerprint reader, although examples are not so limited. Moreover, while system 100 shows two peripheral devices, any number of peripheral devices may be used and be coupled to signal combiner 102.

In some examples, signal combiner 102 may receive a first signal from the first peripheral device 104. As described previously, a signal refers to a digital message that may contain information. In some examples, the first signal may contain information corresponding to the first peripheral device 104. For instance, the first peripheral device 104 may be a magnetic strip reader. In such an example, the first signal may correspond to a successful swipe of a magnetic card that allows the card to be read by the magnetic strip reader.

In some examples, the first signal may be an indication that the first peripheral device 104 is operational. In such examples, the first signal may include a first tone. As used herein, a tone refers to an audible sound used as an indicator. The first tone may correspond to the operational status of the first peripheral device 104. That is, the first tone may indicate that the first peripheral device 104 is operating as intended based on the type of peripheral device.

In some examples, the first signal may be an indication that the first peripheral device 104 is inoperative. In such examples, the first signal may include a second tone corresponding to the inoperative status of the first peripheral device 104. That is, the second tone may indicate that the first peripheral device 104 is not operational. The second tone may be different than the first tone so as to allow for differentiation between the operational and inoperative statuses of the first peripheral device 104.

Signal combiner 102 may further receive a second signal from the second peripheral device 106. The second peripheral device 106 may be a type of peripheral device different than the first peripheral device 104; therefore, the second signal may be different than the first signal. In some examples, the second signal may be an indication that the second peripheral device 106 is operational, and may include a first tone corresponding to the operational status of the second peripheral device 106. In other examples, the second signal may be an indication that the second peripheral device 106 is inoperative and may include a second tone corresponding to the inoperation of the second peripheral device 106. The first tone and/or the second tone corresponding to the second peripheral device 106 may be different than the first tone and/or the second tone corresponding to the first peripheral device 104. That is, the second peripheral device 106 may utilize different tones as indicators from the first peripheral device 104. In some examples, the second peripheral device 106 may use a non-tonal type of indication. For instance, the second peripheral device 106 may use lights as indicators, with a first color of light corresponding to a signal indicating operation of the peripheral device 106 and a second color of light corresponding to a signal indicating inoperation of the peripheral device 106.

System 100 may further include a controller 108. As used herein, a controller refers to a hardware chip, card, or device that interfaces with a peripheral device. Controller 108 may be coupled to signal combiner 102 and may serve to interface with the first peripheral device 104 and/or the second peripheral device 106. In some examples, the controller 108 may receive the combined signal from signal combiner 102. The combined signal may be a combination of a signal received at the signal combiner 102 from the first peripheral device 104 and/or from the second peripheral device 106.

In some examples, controller 108 may be coupled to a speaker. As used herein, a speaker refers to an output device which receives audio input and outputs the audio as audible sound waves. In some examples, the controller 108 may forward the combined signal to the speaker such that the speaker can play the tone or tones contained within the combined signal. As described previously, the combined signal may include one or more audio signals to be played by the speaker. In some examples, the speaker may be integrated within a computing device. In such examples, the first peripheral device 104 and/or the second peripheral device 106 may be coupled to the computing device.

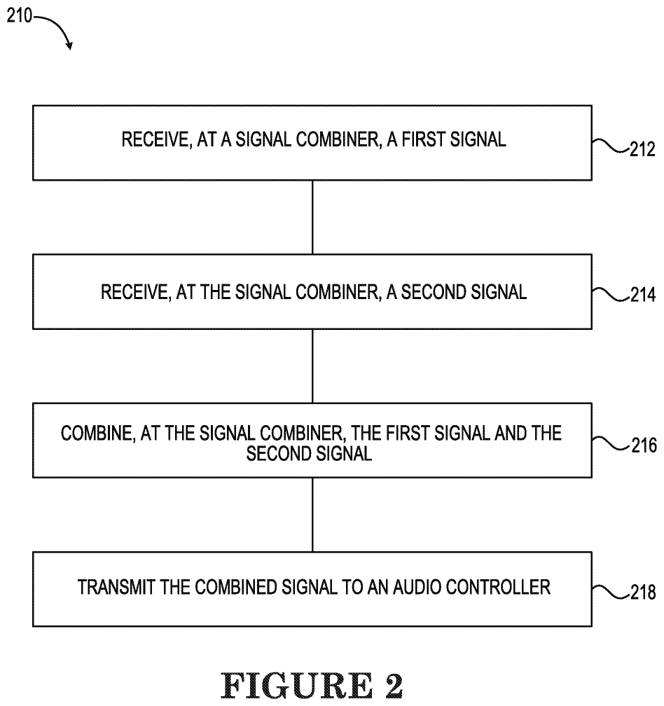

FIG. 2 is an example method 210 for combining signals consistent with the disclosure. At 212, method 210 may include receiving, at a signal combiner, a first signal from a first peripheral device. As described with respect to FIG. 1, the first signal may include information corresponding to the first peripheral device. In some examples, receiving a first signal at 212 may include determining that the first peripheral device is activated. That is, receiving a first signal at 212 may include determining that the first peripheral device is coupled to a computing system and is receiving power such that the peripheral device may be used. Further, in response to the determination that the peripheral device is activated, a signal may be transmitted. The signal may include an indication that the first peripheral device is activated. That is, receiving a first signal at 212 may include receiving a signal indicating activation of the first peripheral device.

At 214, method 210 may include receiving, at the signal combiner, a second signal from a second peripheral device. In some examples, the second peripheral device may be a type of peripheral device that is different than the first peripheral device. Thus, the second signal may be a different type of signal than the first signal received at 212. In some examples, the second signal may include an indication that the second peripheral device is activated. In some examples, the second signal may include an indication that the second peripheral device is connected to a computing system but is not activated.

At 216, method 210 may include combining, at the signal combiner, the first signal and the second signal. As described previously, combining the first signal and the second signal at 216 may include combining the first signal and the second signal into a single signal. In some examples, combining the first signal and the second signal at 216 may include determining that the signal combiner received the first signal at a first time. Combining the first signal and the second signal at 216 may further include determining that the signal combiner received the second signal at a second time. The second time may be different than the first time and may occur after the first time, That is, a determination may be made that the first signal was received at the signal combiner prior to the second signal being received at the signal combiner. In such examples, combining the first signal and the second signal at 216 may include combining the first signal and the second signal such that the first signal occurs first in the combined signal.

Said differently, if the first signal is received prior to the second signal, the signal combiner may combine the first signal and the second signal to allow the first signal to be transmitted before the second signal in the combined signal. As described previously with respect to FIG. 1, the first signal and/or the second signal may include an indicator, such as an audio indicator or a visual indicator. Thus, in examples where the first signal is transmitted prior to the second signal in the combined signal, an indicator associated with the first signal may be activated prior to an indicator associated with the second signal.

In some examples, combining the first signal and the second signal at 216 may include determining that the signal combiner received the first signal and the second signal at approximately a same time. As used herein, “approximately” may include an amount within a particular margin, range, and/or threshold. Thus, the signal combiner may receive the first signal and the second signal at a time that is within a particular margin, range, or threshold period of time. In some examples, the first signal and the second signal may be received simultaneously at the signal combiner. In response to the determination that the first signal and the second signal are received at the signal combiner at an approximately same time, combining the first signal and the second signal at 216 may include combining the first signal and the second signal such that the combined signal transmits the first signal and the second signal simultaneously. In such examples, indicators associated with the first signal and second signal may occur at the same time. For example, the first signal may include an audio indicator, while the second signal may include a visual indicator. When a determination that the first signal and the second signal are received at the signal combiner at the same time is made, the combined signal may result in the audio indicator occurring simultaneously with the visual indicator.

At 218, method 210 may include transmitting the combined signal to an audio controller. As used herein, an audio controller refers to a hardware chip, card, or device that interfaces with audio signals from a peripheral device. An audio controller may, for example, receive an audio input signal and determine that parameters such as volume, tone, or pitch are to be adjusted. The audio controller may then alter and adjust any determined parameters. In some examples, transmitting the combined signal to an audio controller at 218 may include determining that a parameter of the combined signal is to be adjusted and adjusting the parameter.

Method 210 may further include transmitting the combined signal to a speaker. In some examples, the speaker may be integrated within a computing system. In addition, the speaker may be coupled to the audio controller, such that the audio controller may transmit the combined signal to the speaker. In some examples, the audio controller may transmit the combined signal to the speaker subsequent to adjusting parameters of the combined signal. In response, the speaker may play the tone associated with the combined signal.

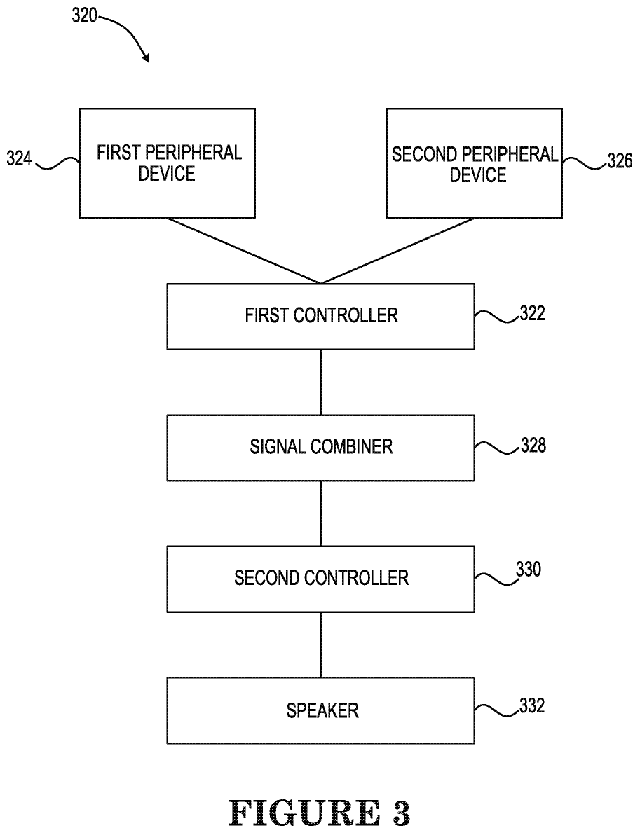

FIG. 3 is another example system 320 including a signal combiner 328 consistent with the disclosure. System 320 may include a first controller 324. The first controller 324 may be a platform controller hub. As described previously, a platform controller hub may be electronic switch or gate to receive a signal from a peripheral device. For example, controller 322 may receive a first signal from a first peripheral device 324 and a second signal from second peripheral device 326. In some examples, the first peripheral device 324 and/or the second peripheral device 326 may be coupled to controller 322 such that controller 322 may receive a first signal from first peripheral device 324 and a second signal from a second peripheral device 326, In some examples, controller 322 may receive a signal including information to activate an indicator associated with the peripheral device. As described previously, controller 322 may include an OR gate, such that a first signal from the first peripheral device 324 and a second signal associated with the second peripheral device 326 may active the OR gate to specify that an indicator associated with the peripheral device is to be activated.

In some examples, the first controller 322 may receive the first signal upon activation of the first peripheral device 324. The first signal may include an indication that the first peripheral device 324 is activated; that is, the first signal received at the first controller 322 may indicate that the first peripheral device 324 is coupled to a computing system or has been used. The first controller 322 may further receive the second signal upon activation of the second peripheral device 326. In some examples, the second signal may include an indication that the second peripheral device 326 is activated. The first controller 322 may receive the first signal from the first peripheral device 324 prior to receiving the second signal from the second peripheral device 326, simultaneous to receiving the second signal from the second peripheral device 326, or subsequent to receiving the second signal from the second peripheral device 326.

System 320 may include a signal combiner 328, Signal combiner 328 may be akin to signal combiner 102, discussed with respect to FIG. 1. As described previously, signal combiner 328 may combine a first signal from a first peripheral device, such as first peripheral device 324, with a second signal from a second peripheral device, such as second peripheral device 326, to produce a combined signal. In some examples, signal combiner 328 may be coupled to the first controller 322. The signal combiner 328 may receive the first signal and the second signal from the first controller 322.

In some examples, the signal combiner 328 may receive a first signal for a first peripheral device 324 from the first controller 322. The signal combiner 328 may determine a type of the first peripheral device 324. That is, the signal combiner 328 may determine what the first peripheral device 324 is. In some examples, the signal combiner 328 may determine the type of first peripheral device 324 based on information contained within the first signal. The first signal may include an identification of the first peripheral device 324. For example, the first peripheral device 324 may be a magnetic strip reader. The first signal may include an identification of the first peripheral device 324 as a magnetic strip reader. Upon receipt of the first signal from the first peripheral device 324, signal combiner 328 may locate the information pertaining to the identity of the first peripheral device 324 and determine that the first peripheral device 324 is a magnetic strip reader. In response to the determined type of the first peripheral device 324, signal combiner 328 may determine a corresponding tone. The tone may be particular to the type of the first peripheral device 324. Said differently, the signal combiner 328 may determine that a first peripheral device 324 is a particular type of peripheral device and, based on the type of peripheral device, determine that a corresponding tone is to serve as an indicator for the first peripheral device 324.

The signal combiner 328 may further determine a tone volume for a tone corresponding to the first peripheral device 324. In some examples, the signal combiner 328 may first determine that a particular tone corresponds to a type of the first peripheral device 324. The signal combiner 328 may then determine that the particular tone is to be played at a particular tone volume. In some examples, the determined tone volume is different than a tone volume included in the first signal. In such examples, signal combiner 328 may adjust the first signal to play the determined tone at the determined tone volume.

System 320 may further include a second controller 330. The second controller 330 may be coupled to the signal combiner 328 such that the second controller 330 may receive the combined signal from the signal combiner 328. Second controller 330 may be akin to controller 108, discussed with respect to FIG. 1. Further, as described with respect to FIG. 2, the second controller 330 may be akin to the audio controller receiving the combined signal at 218. In some examples, the second controller 330 may provide additional refinement of the combined signal. For example, as discussed with respect to FIG. 2, the second controller 330 may perform the functions of the audio controller, including determining that parameters such as pitch or volume of the combined signal are to be adjusted. In such examples, the second controller 330 may adjust the parameters of the combined signal.

System 320 may further include a speaker 332. As discussed with respect to FIG. 1, speaker 332 may serve to receive an audio input and output the signal in an audible fashion. Speaker 332 may be coupled to the second controller 330. In some examples, the speaker 332 may receive the combined signal from the second controller 330. Speaker 332 may then output the combined signal according to the parameters of the combined signal. That is, speaker 332 may sound the tone or tones included within the combined signal according to the parameters, such as volume and pitch, of the combined signal.

In the foregoing detail description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to any number of such elements and/or features.

What is claimed:

1. A system, comprising:
a signal combiner to:
receive a first signal from a first peripheral device;
receive a second signal from a second peripheral device; and
combine the first signal and the second signal into a combined signal; and
a controller coupled to the signal combiner to receive the combined signal.

2. The system of claim 1, further comprising a speaker coupled to the controller to emit the combined signal.

3. The system of claim 2, wherein the speaker is integrated with a computing device.

4. The system of claim 1, wherein:
the first signal is an indication that the first peripheral device is operational; and
the first signal includes a first tone corresponding to the operation of the first peripheral device.

5. The system of claim 1, wherein:
the first signal is an indication that the first peripheral device is inoperative; and
the first signal includes a second tone corresponding to the in operation of the first peripheral device.

6. A method, comprising:
receiving, at a signal combiner, a first signal from a first peripheral device;
receiving, at the signal combiner, a second signal from a second peripheral device;
combining, at the signal combiner, the first signal and the second signal; and
transmitting the combined signal to an audio controller.

7. The method of claim 6, further comprising transmitting the combined signal to a speaker.

8. The method of claim 6, wherein receiving a first signal from a first peripheral device includes:
determining that the first peripheral device is activated; and
transmitting a signal indicating activation of the first peripheral device.

9. The method of claim 6, wherein combining the first signal and the second signal includes:
determining that the signal combiner received the first signal at a first time;
determining that the signal combiner received the second signal at a second time different than the first time; and
combining the first signal and the second signal such that the first signal occurs first in the combined signal.

10. The method of claim 6, wherein combining the first signal and the second signal includes:
determining that the signal combiner received the first signal and the second signal at approximately a same time; and
combining the first signal and the second signal such that the first signal and the second signal are transmitted simultaneously in the combined signal.

11. A system, comprising:
a first controller to:
receive a first signal from a first peripheral device; and
receive a second signal from a second peripheral device;
a signal combiner coupled to the first controller to combine the first signal and the second signal into a combined signal;
a second controller coupled to the signal combiner to receive the combined signal; and
a speaker coupled to the second controller to emit the combined signal.

12. The system of claim 11, further comprising the signal combiner to:
determine a type of the first peripheral device; and
determine a corresponding tone based on the type of the first peripheral device.

13. The system of claim 11, further comprising the signal combiner to:
determine a tone volume for a tone corresponding to the first peripheral device; and
adjust the first signal in response to the determined tone volume.

14. The system of claim 11, further comprising:
the first controller to receive the first signal upon activation of the first peripheral device; and
the first controller to receive the second signal upon activation of the second peripheral device.

15. The system of claim 11, wherein the first signal includes an indication that the first peripheral device is successfully activated.
